(19) United States
(12) Patent Application Publication
(10) Pub. No.: US 2004/0071136 A1
(43) Pub. Date: Apr. 15, 2004

(54) Message transfer device and method for transferring messages

(76) Inventors: Josef Laumen, Hildesheim (DE); Andreas Schmidt, Braunschweig (DE); Gunnar Schmidt, Wolfenbuttel (DE)

Correspondence Address: BELL, BOYD & LLOYD, LLC, P. O. BOX 1135, CHICAGO, IL, 60690-1135, US

(21) Appl. No.: 10/470,562

(22) PCT Filed: Jan. 18, 2002
(86) PCT No.: PCT/DE02/00154

(30) Foreign Application Priority Data
Jan. 29, 2001 (DE) 101-03-799.6

(51) Int. Cl. H04L 12/28

(52) U.S. Cl. 370/390; 370/432

(57) ABSTRACT

The invention relates to a message transfer device and to a method for transferring messages comprising at least one group header field, which allows a differentiated classification by extension of the value range of the group header field and/or evaluation of another group header field.

The present invention relates generally to a messaging device and a method for forwarding messages and, more specifically, to a device and a method for forwarding messages having at least one group header field.

In the mobile communications environment the Global System for Mobile Communications, or GSM for short, has become established in recent years, providing not only voice telephony but also the possibility of forwarding short text messages of up to 160 characters in length. This service is widely known under the designation Short Message Service, or SMS for short, and is described for example in “GSM 03.40 version 7.4.0, Release 1998; Digital Cellular Telecommunications System; Technical realisation of the Short Message Service (SMS)”. SMS transmission takes place in so-called push mode in which the messages are forwarded by a messaging device, in this case known as a Short Message Service Center, to a receiver unit as soon as the receiver unit is ready to receive. A receiver unit user therefore has the possibility of determining the time of transmission or of refusing to accept the message.

Information about the sender is normally transmitted with the SMS in a so-called header field, reception of such messages normally being free of charge, whereas a charge is payable for sending. Some service providers currently allow such messages to be sent free of charge, a distinction being drawn between two different concepts, namely allowing the sender to send only after viewing advertising efforts, and, secondly, incorporating an advertising text into the message. In the first case this may involve banners on an Internet page on which the service is offered, whereas in the second case an advertising message or even a link or a Web address may be included. Occasionally concepts are also found whereby both of the above concepts are used in combination.

Mobile communications are about to see the introduction of a new standard, the so-called Universal Mobile Telecommunication System (UMTS). With UMTS it will also be possible to send messages incorporating multimedia content, the corresponding service being known as Multimedia Messaging Service, or MMS for short. This service is described in “3G TS 23.140 version 3.0.1, Release 1999, Third Generation Partnership Project; Technical Specification Group Terminals; Multimedia Messaging Service (MMS); Functional Description; Stage 2”.

In contrast to SMS, which exclusively allows text messages to be transmitted, with MMS it is therefore possible to transmit audio, image and/or video content in a message.

In addition to multimedia enhancement, MMS is also to offer the possibility of forwarding messages optionally in so-called push mode or in so-called pull mode. In so-called pull mode only so-called header fields of a message are transmitted to the receiver unit. Being informed, for example, of the message addressee, the receiver unit user can decide when and if message delivery is to take place. It is also to be possible to store individual settings of a receiver unit in so-called profiles in the messaging device, it being proposed that these profiles be stored in a so-called MMS user database. It should therefore be possible always to forward messages from certain senders in a certain mode, i.e. in push or pull mode.

In addition to sender information, the header fields can also contain further information. Thus, for example, so-called e-mails have a subject field as a header field. In the special area of mobile communications, the Wireless Application Protocol, or WAP for short, has likewise become established as a standard. As described in “WAP-209-MMS Encapsulation, Release 2000; Wireless Application Protocol; WAP Multimedia Messaging Service; Message Encapsulation; MMS Proposed SCD 1.0”, the WAP standard provides the possibility of classifying messages into different groups, a group header field being proposed for this purpose in order to group the messages by content, namely into the groups: Personal, Advertisement, Informational and Auto.

In “WAP-203-WSP, Version 4-May-2000; Wireless Application Protocol, Wireless Session Protocol Specification; Chapter 8.4: “Header Encoding”” it is proposed to provide the group header field designated X-MMS Message Class with a field name and a field value which allows the MMS to be classified into the four abovementioned groups.

There is a need for a messaging device and a method for forwarding messages which will better meet the requirements of users of receiver units as well as those of the message transmission device, which are normally the service providers.

The object of the present invention is therefore to specify a messaging device and a method for forwarding messages which will offer increased convenience for the receiver unit user and allow greater versatility of use.

This object is achieved according to the invention by a messaging device having the features detailed in claim 1, and by a method having the features detailed in claim 7, preferred embodiments being defined in the respective dependent claims.

In particular the invention proposes a messaging device for forwarding messages with at least one group header field to a receiver unit. The device incorporates a mechanism for evaluating header fields of the message to be transmitted, said mechanism discriminating between at least four different values in the group header field, of which there are at least one, and/or evaluating at least one additional group header field. The messaging device according to the invention therefore allows the introduction of sub-classes. A first possibility consists in defining the sub-classes in the already proposed group header field by supplementing or increasing the value range of same. A second possibility consists in creating another group header field which then allows a correspondingly differentiated classification into message groups, said header field being able to be encoded and/or filled with content on the one hand independently of, and on the other as a function of, the first group header field and particularly of the four classes described above. Finally a third possibility consists in both expanding the value range of the first group header field and providing a second group header field. In each case it is possible using the messaging device according to the invention to subdivide messages into a plurality of groups and to handle these according to predefined processing and/or transmission modes, retention of the currently obtaining classification ensuring compatibility with existing systems.

Advantageously, the messaging device according to the invention has a mechanism for modifying at least one value of a group header field. By this means the service provided can, for example, set the value of a group header field in such a way that a receiver unit user cannot refuse to receive the message. This feature is particularly advantageous if messaging is to be offered as an advertising-financed service, as in this case the transmission of the so-called internal advertising is mandatory.

In a preferred embodiment, the messaging device incorporates a mechanism for storing receiver-unit-specific data which can interact with the mechanism for evaluating group header fields and/or the mechanism for modifying a group header field. This makes it possible, for example, for a receiver unit user to group messages according to sender information, e.g. to define it in a grouping comprising friends; family; colleagues; authorities; companies; associations; government agencies and organizations with security responsibilities and others. Classification of a message into one of the abovementioned groups can then be used to select different transmission modes, i.e. at a specific time, in pull or push mode, etc., it also being generally possible to refuse messages from a particular sender group. This last mentioned option constitutes an effective remedy against so-called spamming, i.e. unwanted advertising. However, if a so-called anti-spamming function is enabled, the abovementioned mandatory transmission of so-called internal advertising messages must be provided. The present advertisement grouping cannot provide this functionality.

In addition it is preferred that the mechanism for modifying at least one value of a group header field interacts with the mechanism for evaluating header fields. In this embodiment it is therefore possible to group messages for fine classification on the basis of header field information, even if such a grouping is not provided or intended by the addressee of the message. For example, a message classified as personal from a particular sender or particular sender group can be classified as advertisement and in particular external advertisement in order to prevent unwanted transmission. Even in the case of so-called subscription services for which a service provider transmits information messages as requested, pre-selection on the basis of e.g. key words can therefore be achieved.

Advantageously the mechanism for storing receiver-unit-specific data interacts with the receiver unit itself, so that the receiver unit user can modify his stored profile using the receiver unit itself.

If the possibility of the receiver unit user modifying his stored profile exists, the messaging device must be implemented in such a way that the mechanism for storing receiver-unit-specific data includes a storage area which cannot be modified by means of the receiver unit and/or by means of a mechanism which interacts with the mechanism for evaluating header fields and/or the mechanism for modifying the value of at least one group header field, in order to ensure, for example, that the advertising of the advertising-financed service reaches the required recipient.

In addition to the messaging device according to the invention, the invention likewise proposes a method for forwarding messages with at least one group header field, said method involving the following steps: receiving a message; storing the message; determining the content or evaluating the group header field(s); processing the message according to a mode dependent on the content of the group header field(s), the value range of the group header field(s) being greater than four and/or extending over at least two group header fields. The method according to the invention therefore enables messages to be classified into more than the four known classes, the increased classifiability resulting from increasing the value range of the existing group header field and/or providing at least one additional group header field which can be encoded or provided with content independently or as a function of the group header field and/or the content present therein. For example, messages classified into the Informational message class could be subdivided into sub-groups: politics; art; culture; weather; economy/stock market; sport; leisure; travel; entertainment; technology, yet more sub-classes being obviously possible.

Advantageously, prior to the step of evaluating or determining the content of the group header field(s), the method includes the steps: determining the content of at least one non-group header field and/or non-header field; and modifying the content of a group header field depending on the result of the preceding step. This enables messages to be classified into sub-classes which do not have any such subdivision. For example, it is possible to combine messages according to addressee groups and transmit them according to the addressee group.

Finally it is preferred that, for the method according to the invention, the processing mode is selected from: Do not send/Delete; Pull transmission; Push transmission; Push-in-pull transmission.

Further advantages and features of the present invention will additionally emerge from the following detailed description of some currently preferred embodiments, it being understood that although reference is made only to Multimedia Messaging Service in the following, corresponding application to any other message types such as SMS, e-mail and the like is also possible.

In a first preferred embodiment of the inventive method for forwarding messages, the value range of a group header field is expanded compared to the currently proposed four registration options Personal, Advertisement, Informational and Auto. The messaging device according to the invention is therefore implemented in such a way that it differentiates between more than four different values in the one group header field. The message to be transmitted therefore includes, as hitherto, various header fields such as a “To” header field and a group header field. The group header field which is also known as the XMMS Message Class carries in hexadecimal notation the field name 0×0A (decima1:10) to which at least one octet has been appended for the field value. The first octet decides on the type and length of the encoding, there being a total of four options for encoding the field value. In this example, the group header field value assumes values from the value range 128 to 255 and consequently consists of a single octet. In order to be able to ensure compatibility with other systems, the encodings in Personal, Advertisement, Informational and Auto are retained by means of octets 128, 129, 130 and 131 respectively. In the following table a typically expanded encoding is proposed which enables the value range to be expanded by up to 124 further type classes or sub-classes:

TABLE 1
Message Class

| Name | Number | Coding |
|---|---|---|
| Personal | 0 | <Octet 128> |
| Advertisement | 1 | <Octet 129> |
| Informational | 2 | <Octet 130> |
| Auto | 3 | <Octet 131> |
| . . . | . . . | Buffer |
| Friends | 4 | <Octet 150> |
| Family | 5 | <Octet 151> |
| Colleagues | 6 | <Octet 152> |
| Authorities | 7 | <Octet 153> |
| Companies | 8 | <Octet 154> |
| Associations | 9 | <Octet 155> |
| Government agencies | 10 | <Octet 156> |
| and organizations | | |
| with security | | |
| responsibilities | | |
| Other | 11 | <Octet 157> |
| . . . | . . . | Buffer |
| Internal advertising | 12 | <Octet 170> |
| External adveritising | 13 | <Octet 171> |
| . . . | . . . | Buffer |
| Politics | 14 | <Octet 180> |
| Art/culture | 15 | <Octet 181> |
| Weather | 16 | <Octet 182> |
| Economy/stock market | 17 | <Octet 183> |
| Sport | 18 | <Octet 184> |
| Leisure/travel | 19 | <Octet 185> |
| Entertainment | 20 | <Octet 186> |
| Technology | 21 | <Octet 187> |
| . . . | . . . | Buffer |

Using the proposed encoding, differentiated classification into groups is possible, messages from the same main group, e.g. Advertisement, also being able to be handled differently. It shall be assumed in the following that, one the one hand, an advertising message of the service provider (internal advertising) and, on the other hand, an advertising message of any third party (external advertising) is to be forwarded. The messaging device, which in this case is an MMS server, receives the two messages and evaluates the two group header fields. If the messaging device detects Octet 170 encoding, as may be the case e.g. for internal advertising, it will transmit the message to the receiver unit in so-called push mode, i.e. without it having been possible for the receiver unit user to select whether and when he would like to receive the message. Alternatively it would also be possible to use a push-in-pull mode in which, although the user is able to determine the time he would like to receive the message, he is unable to completely refuse the message.

In contrast, the messaging device will handle an advertising message which does not have Octet 170 encoding or has Octet 171 encoding according to how it has been stored in the user profile, for example. In this case there additionally exist the options of not transmitting the message at all or deleting it and of forwarding the message in so-called pull mode, i.e. transmitting only the header information indicating to the receiver unit user that a corresponding message is available for downloading.

As a further addition to prevent so-called spamming or unwanted advertising, the messaging device can also perform modification of the relevant encoding. If e.g. an advertising message has Octet 170 encoding even though it is not internal advertising, this coding can, for example, be deleted if the information of another header field, e.g. the “To” field, does not correlate with the encoding.

Another option for modifying a group header field consists in the messaging device evaluating the “To” header field and performing appropriate encoding which would be in the range Octet 150 to Octet 157 in accordance with the above table.

Finally, it is likewise possible to perform encoding of a group header field depending on the message content itself. For example, the message could be searched for certain key words, in which case classification could be performed using the range Octet 180 to Octet 187 in accordance with Table 1 above.

In a second preferred embodiment of the invention, an additional group header field which can be termed XMMS sub-class, for example, is introduced for differentiated classification and corresponding evaluation. For example, this group header field could be designated 0×18 (decimal:24), followed by an octet from the value range 128 to Octet 255. By introducing this group header field, the encoding combinations listed in the following table can be represented:

TABLE 2

| | |
|---|---|
| Message Class | Message Sub-Class |

| Name | No. | Encoding | Name | No. | Coding |
|---|---|---|---|---|---|
| Personal | 0 | <Octet 128 > | Friends | 0 | <Octet 128> |
| | | | Family | 1 | <Octet 129> |
| | | | Colleagues | 2 | <Octet 130> |
| | | | Authorities | 3 | <Octet 131> |
| | | | Companies | 4 | <Octet 132> |
| | | | Associations | 5 | <Octet 133> |
| | | | Government | 6 | <Octet 134> |
| | | | agencies and | | |
| | | | organizations | | |
| | | | with security | | |
| | | | responsibilities | | |
| | | | Other | 7 | <Octet 135> |
| | | | . . . | . . . | Buffer |
| Adver- | 1 | <Octet 129> | Internal | 8 | <Octet 160> |
| tisement | | | External | 9 | <Octet 161> |
| | | | . . . | . . . | Buffer |
| Infor- | 2 | <Octet 130> | Politics | 10 | <Octet 170> |
| mational | | | Art/culture | 11 | <Octet 171> |
| | | | Weather | 12 | <Octet 172> |
| | | | Economy/ | 13 | <Octet 173> |
| | | | stock market | | |
| | | | Sport | 14 | <Octet 174> |
| | | | Leisure/ | 15 | <Octet 175> |
| | | | travel | | |
| | | | Entertainment | 16 | <Octet 176> |
| | | | Technology | 17 | <Octet 177> |
| | | | . . . | . . . | Buffer |
| Auto | 3 | <Octet 131> | — | 18 | <Octet 250> |
| | | | . . . | . . . | Buffer |

This encoding option makes it possible to also provide the differentiated classification subsequently or optionally, as the first group header field with the subdivision into four classes is maintained unchanged.

Through the introduction of an additional group header field, a wide variety of requirements of the service provider and of the receiver unit user can be taken into account by means of a stored profile, irrespective of whether or not the addressee has a corresponding encoding option. For example, the receiver unit user could store in his profile a table in which it is defined that certain addressees are assigned certain sub-classes. For instance, the message of a friend whose directory number or sender ID is known can therefore be encoded in the second group header field with Octet 128, so that evaluation with the result Octet 128 in the first group header field and Octet 128 in the second group header field results in a message of this kind only being forwarded outside business hours, whereas an Octet 128 encoding in the first group header field and Octet 132 in the second group header field results in such messages being transmitted during business hours only.

This proposed encoding mode therefore permits the introduction of a total of 128 sub-classes in addition to classification into four main classes in the first group header field. If a still further differentiated subdivision is required, it would also be possible to perform corresponding encoding of the second group header field according to the value of the first group header field, as illustrated by way of example in the following Table 3:

TABLE 3

| | |
|---|---|
| Message Class | Message Sub-Class |

| Name | No. | Encoding | Name | No. | Encoding |
|---|---|---|---|---|---|
| Personal | 0 | <Octet 128> | Friends | 0 | <Octet 128> |
| | | | Family | 1 | <Octet 129> |
| | | | Colleagues | 2 | <Octet 130> |
| | | | Authorities | 3 | <Octet 131> |
| | | | Companies | 4 | <Octet 132> |
| | | | Associations | 5 | <Octet 133> |
| | | | Government | 6 | <Octet 134> |
| | | | agencies and | | |
| | | | organizations | | |
| | | | with security | | |
| | | | responsibilities | | |
| | | | Other | 7 | <Octet 135> |
| | | | . . . | . . . | Buffer |
| Adver- | 1 | <Octet 129> | Internal | 0 | <Octet 128> |
| tisement | | | External | 1 | <Octet 129> |
| | | | . . . | . . . | Buffer |
| Infor- | 2 | <Octet 130> | Politics | 0 | <Octet 128> |
| matinal | | | Art/culture | 1 | <Octet 129> |
| | | | Weather | 2 | <Octet 130> |
| | | | Economy/stock | 3 | <Octet 131> |
| | | | market | | |
| | | | Sport | 4 | <Octet 132> |
| | | | Leisure/travel | 5 | <Octet 133> |
| | | | Entertainment | 6 | <Octet 134> |
| | | | Technology | 7 | <Octet 135> |
| | | | . . . | . . . | Buffer |
| Auto | 3 | <Octet 131> | − | 0 | <Octet 128> |
| | | | . . . | . . . | Buffer |

On the basis of this encoding, a sub-grouping into 128 sub-groups or sub-classes is available for each encoding of the first group header field.

Obviously a combination of the encodings according to Tables 1 and 3 is also possible in order to achieve yet more possible combinations, the option also existing of providing further group header fields should this be necessary, e.g. in order to provide a regional subdivision of the senders or other similar detailed groupings.

Although in the aforegoing the present invention has been described wholly with reference to currently preferred embodiments, the average person skilled in the art should recognize that a wide variety of extension possibilities exist, features of one embodiment also being optionally combinable with features of other embodiments.

To summarize, it can be established that the method for forwarding messages according to the invention and the messaging device according to the invention allow a further subdivision into sub-classes, enabling both the interests of a service provider and of a receiver unit user to be taken into account, as has been disclosed, for example, in the differentiation between internal and external advertising which on the one hand enables unwanted advertising such as spamming to be prevented (user requirement) and, on the other hand, ensures that messages of the service provider himself are mandatorily transmitted (service provider requirement).

1. Messaging device for forwarding messages with at least one group header field to a receiver unit, said device incorporating a mechanism for evaluating header fields of the message to be transmitted which differentiates between more than four different values in the group header field, of which there is at least one, and/or evaluates at least one further group header field.

2. Messaging device according to claim 1, wherein there is provided a mechanism for modifying at least one value of a group header field.

3. Messaging device according to claim 1 or 2, wherein the mechanism for evaluating header fields and/or the mechanism for modifying at least one value of a group header field interact(s) with a mechanism for storing receiver-unit-specific data.

4. Messaging device according to claim 2 or 3, wherein the mechanism for evaluating at least one value of a group header field interacts with the mechanism for evaluating header fields.

5. Messaging device according to claim 3 or 4, wherein the mechanism for storing receiver-unit-specific data interacts with the receiver unit.

6. Messaging device according to one of claims 3 to 5, wherein the mechanism for storing receiver-unit-specific data incorporates a memory area which is not modifiable by means of the receiver unit, and/or is modifiable by means of a mechanism which interacts with the mechanism for evaluating header fields and/or the mechanism for modifying at least one value of a group header field.

7. Method for forwarding messages with at least one group header field, comprising the steps:
Receiving a message
Storing the message
Evaluating the group header field(s)
Processing the message according to a mode dependent on the content of the group header field(s),
the value range of the group header field(s) being greater than four and/or extending over at least two group header fields.

8. Method according to claim 7, comprising, prior to the step of evaluating the group header field(s):
Determining the content of at least one non-group header field and/or non-header field;
Modifying the content of a group header field depending on the result of the preceding step

9. Method according to claim 7 or 8, wherein the processing mode is selected from:
Do not send/delete;
Pull transmission;
Push transmission;
Push-in-pull transmission;
